(19) United States
(12) Patent Application Publication
(10) Pub. No.: US 2010/0327963 A1
(43) Pub. Date: Dec. 30, 2010

(54) Active Snubbers Providing Acceleration, Damping, and Error Correction

(75) Inventor: Matthew S. Taubman, Richland, WA (US)

Correspondence Address: BATTELLE MEMORIAL INSTITUTE;ATTN: IP SERVICES, K1-53, P. O. BOX 999, RICHLAND, WA, 99352, US

(73) Assignee: BATTELLE MEMORIAL INSTITUTE, Richland, WA (US)

(21) Appl. No.: 12/757,587

(22) Filed: Apr. 9, 2010

Related U.S. Application Data
(63) Continuation-in-part of application No. 12/492,390, filed on Jun. 26, 2009.

(51) Int. Cl. H02M 1/34

(52) U.S. Cl. 327/551

(57) ABSTRACT

An active snubber operates, in part, to compel switching components, such as switch-mode power supplies and converters, to attain desired values rapidly, albeit temporarily, during which time there is sufficient time for a power supply's internal regulation system to sustain these values independently. The invention can dampen ringing, accelerate response time, and correct erroneous responses of the output of the switching converter. In one embodiment, the active snubber, which is operably connected to the output of a switching component that has a switching or ringing frequency, f₁, and that is modulated by a signal generator at a frequency, f₂, is characterized by an operable connection to the output of a buffer connected to the signal generator. The buffer provides a reference voltage that is equal to the switching component output voltage at the modulation frequency at f₂.

### PRIORITY

This invention claims priority from, and is a continuation-in-part of, currently pending patent application Ser. No. 12/492,390, filed Jun. 26, 2009, which is incorporated herein by reference.

### STATEMENT REGARDING FEDERALLY SPONSORED RESEARCH OR DEVELOPMENT

This invention was made with Government support under Contract DE-AC0576RL01830 awarded by the U.S. Department of Energy. The Government has certain rights in the invention.

### BACKGROUND

Switch-mode power supplies, herein referred to as switching converters, are ubiquitous today, being commonplace in devices ranging from personal computers to large-scale motor control systems. However, a common side-effect of the switching action of the components in such power supplies is ringing, comprising under-damped circuit oscillations at frequencies determined by the self-inductance and capacitance of all the components exposed to the steep transients of the switching waveforms. Ringing can contribute greatly to electro-magnetic interference (EMI), and can impair circuit performance. Components involved in ringing can include everything from resistors, capacitors, inductors, connecting wires, circuit board tracks, and switching transistors.

Another side effect of switching converters is the presence of residual signals on the output at the switching frequency of the converter. For the purposes of the action of snubber networks on such signals, both the effects of ringing and residual signals at the switching frequency are herein referred to as occurring at frequency f₁.

One traditional method of minimizing oscillations and ringing or residual switching signals at f₁, is the use of a static snubber network, which typically includes resistors, inductors, and capacitors in series in appropriate configurations. Depending on the configuration being used, the operation of a snubber is to isolate the particular frequency at which the ringing is occurring and then expose it to a lossy element, nominally a resistor. Typically, the optimum resistance is one that will allow optimum current flow through the resonant structure, while still dissipating as much of the energy at that frequency as possible. Too large, and there will be insufficient current flow to allow damping; too small, and the large current flow at the selected frequency will just oscillate around the circuit through the structure without being significantly dissipated.

An added complication can occur when using snubber networks in power converters when the output value has to be modulated at a second frequency f₂, other than the switching frequency f₁, particularly when the snubber does not contain all three components; capacitor, inductor and resistor. If the modulation depth at f₂ is large, e.g., from zero to the maximum output level of the power converter, then significant current can flow through the snubber network. This results in a large parasitic flow of current at f₂, which has nothing to do with the action and purpose of the snubber to damp ringing due to the switching action, or residual signals at switching frequency f₁. While this energy flow may not impede the effectiveness of the snubber, it can cause excessive heating or even destroy an inadequate resistor or switching element. Such power dissipation wastes energy, and the periodic nature of the energy flow in and out of other storage elements in a switch-mode converter may disturb regulation and response characteristics. Accordingly, an improved snubber is needed, particularly one that is active and can accommodate the output of a switching converter that has a switching frequency, f₁, and whose output amplitude is modulated at a frequency, f₂.

### SUMMARY

The present invention includes an active snubber that operates, in part, to compel switch-mode power supplies and converters, referred to herein as switching converters, to attain desired values rapidly, albeit temporarily, during which time there is sufficient time for the power supply's internal regulation system to sustain this level. The invention can dampen ringing, accelerate response time, and correct erroneous responses of power supply rails to rapid input control signals.

In one embodiment, the active snubber, which is operably connected to the output of a switching controller that has a switching (or ringing) frequency, f₁, and that is modulated by a signal generator at a frequency, f₂, is characterized by an operable connection to the output of a buffer connected to the signal generator. The buffer provides a reference voltage that is equal to the switching converter output voltage and that is modulated at f₂. In this manner, the active snubber links passive snubber components to a moving, low-impedance, active reference rather than being connected directly to ground or some master power supply rail.

The active snubber can further comprise a variable phase adjustment component and a variable amplitude adjustment component connected to the buffer and operating on the buffer drive signal.

In preferred embodiments, the potential difference across the snubber is substantially null at f₂.

In some embodiments, a linear regulator follows the switching converter and the active snubber, wherein the buffer input is connected to the linear regulator output. Furthermore, the active snubber can comprise a variable phase adjustment component and a variable amplitude adjustment component connected to the buffer and operating on the buffer drive signal.

The purpose of the foregoing abstract is to enable the United States Patent and Trademark Office and the public generally, especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

Various advantages and novel features of the present invention are described herein and will become further readily apparent to those skilled in this art from the following detailed description. In the preceding and following descriptions, the various embodiments, including the preferred embodiments, have been shown and described. Included herein is a description of the best mode contemplated for carrying out the invention. As will be realized, the invention is capable of modification in various respects without departing from the invention. Accordingly, the drawings and description of the preferred embodiments set forth hereafter are to be regarded as illustrative in nature, and not as restrictive.

### DESCRIPTION OF DRAWINGS

Embodiments of the invention are described below with reference to the following accompanying drawings.

FIG. 1 is an illustration depicting an active snubber according to embodiments of the present invention.

FIG. 2 is an illustration depicting an active snubber and components for making phase and amplitude adjustments according to embodiments of the present invention.

FIG. 3. is an illustration depicting an active snubber operating effectively in a feed forward manner according to embodiments of the present invention, wherein the switching converter has a slower response than the waveform delivered by the signal generator.

FIG. 4 is an illustration depicting an active snubber and a linear regulator according to embodiments of the present invention, wherein the switching converter has a slower response than the waveform delivered by the signal generator, and where the switching converter also has a slower response than the linear regulator that follows it.

### DETAILED DESCRIPTION

The following description includes the preferred best mode of one embodiment of the present invention. It will be clear from this description of the invention that the invention is not limited to these illustrated embodiments but that the invention also includes a variety of modifications and embodiments thereto. Therefore the present description should be seen as illustrative and not limiting. While the invention is susceptible of various modifications and alternative constructions, it should be understood, that there is no intention to limit the invention to the specific form disclosed, but, on the contrary, the invention is to cover all modifications, alternative constructions, and equivalents falling within the spirit and scope of the invention as defined in the claims.

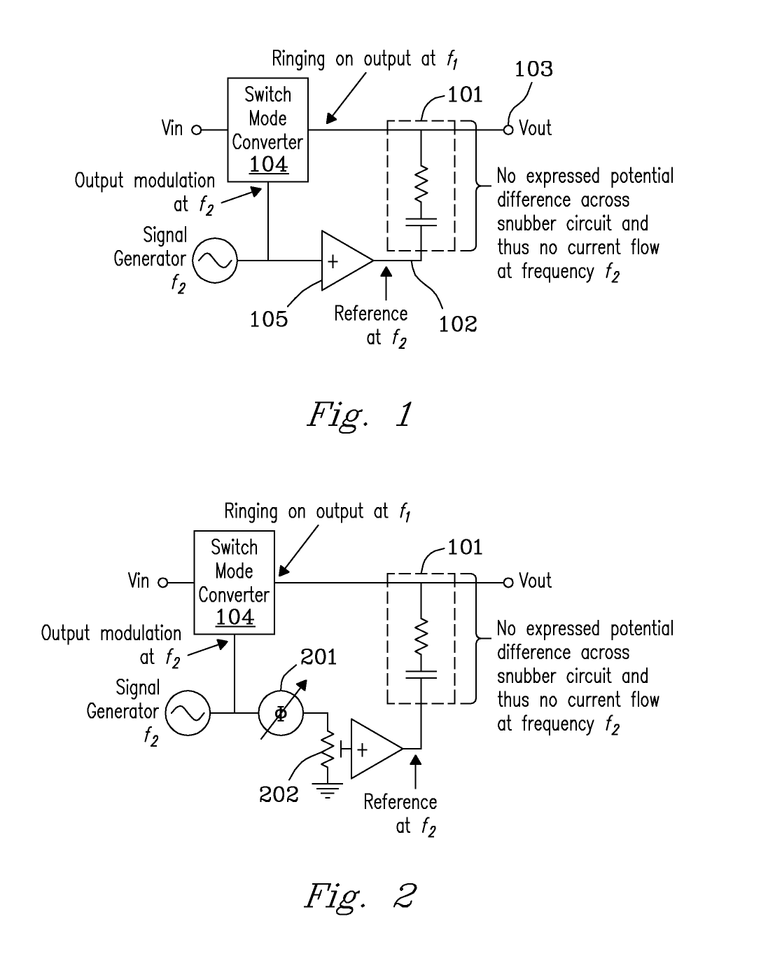

FIGS. 1-4 show a variety of embodiments of the present invention. Referring first to FIG. 1, a basic embodiment of the active snubber is depicted, wherein the end of the active snubber 101, which is traditionally tied to ground or some other return path, is instead fixed to the output 102 of a low-impedance buffer or amplifier 105. This buffer provides a reference voltage equal to the output voltage 103 of the switching converter 104, and which varies at the required modulation rate of the converter, f₂.

With adjustment of amplitude and phase of the information driving the amplifier or buffer, so that the signal at f₂ appearing at the output of the buffer exactly matches that at the output of the switching converter in both amplitude and phase, the snubber network is not exposed to a net voltage change at frequency f₂. At frequency f₁ on the other hand, the buffer output forms an effective ground connection because it is not driven or varying at frequency f₁. This simple, effective technique allows the passive snubber network to operate as designed for suppression of the switching or ringing at f₁ while being immune to frequency f₂. The amplifier or buffer only needs to be powerful enough to support the snubber network at the level of current it is likely to pass in order to suppress the ringing at f₁, and actually does not need to provide any current at frequency f₂, because there is no potential difference appearing across the snubber at frequency f₂. Referring to FIG. 2, mechanisms are explicitly shown for varying the phase 201 and amplitude 202 of the buffer drive signal to attain optimum nulling of voltage across the passive snubber network at frequency f₂.

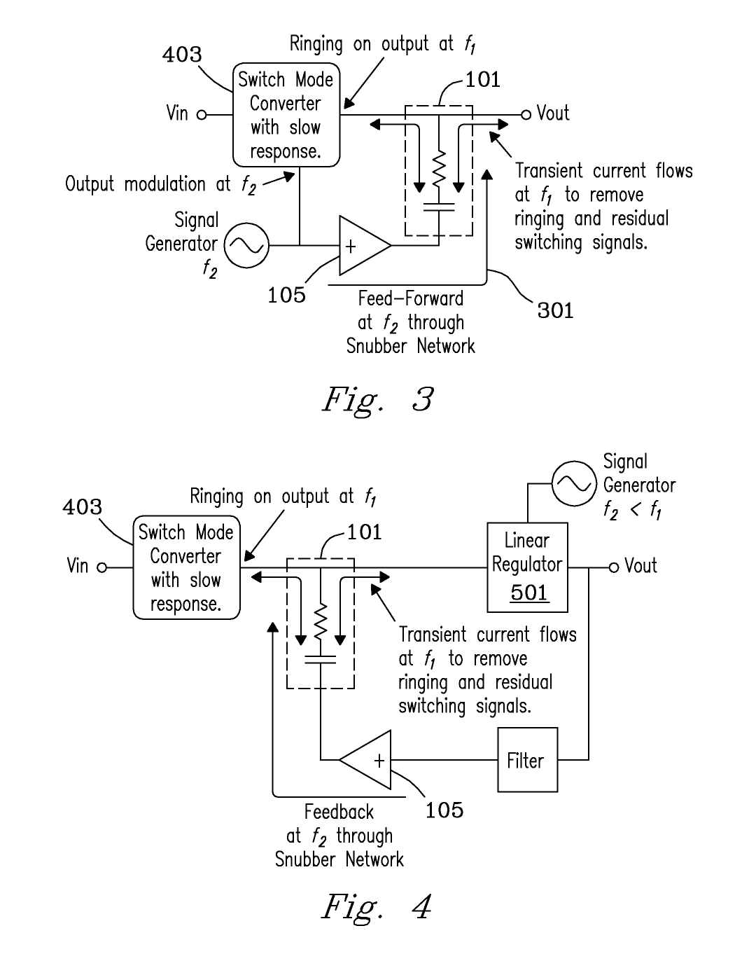

The configuration of the active snubber shown in FIG. 2 will, in effect, become a feed-forward network in the event that the modulation imposed on the switching component approaches the limits of the unit's ability to respond. At, or near, the limit, distortion of the modulation waveform would appear at its output. In this case, the presence of the active snubber will feed correct waveform information forward 301 from the buffer to the output and speed up, or clean up, the output waveform. Since the buffer is correcting transient behavior it doesn't handle significant power in comparison to the switching converter. This allows the switching converter and active snubber in combination to work at faster and/or with deeper modulation levels than might otherwise be possible. An illustration of the feed-forward operation is shown in FIG. 3, wherein the switching converter 403 has a slower response than the waveform delivered by the signal generator.

In another embodiment, a switching converter is followed by a faster linear regulator 501. This architecture can yield efficient, quiet, and accurate regulation, wherein the switching converter is tracking the linear regulator output, which is in turn modulated. During operation, the response of the switching converter may be too slow to keep up with the demands of the more agile linear controller, which follows. To compensate, a filtered and buffered copy of the output from the linear regulator is used to clean up the waveform generated by the switching converter via the active snubber. In many aspects, the instant embodiment can be viewed as a case of boot-strapping via the active snubber. Additional details are described in U.S. patent application Ser. No. 12/492,390, filed on Jun. 26, 2009, which details are incorporated herein by reference. The configuration is depicted by the illustration in FIG. 4, wherein the switching converter 403 has a slower response than the waveform delivered by the signal generator, and where the switching converter also has a slower response than the linear regulator that follows it. The configuration is an exemplary one for laser controllers, and it can yield agile, quiet and efficient operation.

While a number of embodiments of the present invention have been shown and described, it will be apparent to those skilled in the art that many changes and modifications may be made without departing from the invention in its broader aspects. The appended claims, therefore, are intended to cover all such changes and modifications as they fall within the true spirit and scope of the invention.

We claim:

1. An active snubber operably connected to the output of a switching converter that has a switching, or ringing, frequency, f₁, and that is modulated by a signal generator at a frequency, f₂ the active snubber characterized by an operable connection to the output of a buffer connected to the signal generator, the buffer providing a reference voltage that is equal to the switching component output voltage and that is modulated at f₂.

2. The active snubber of claim 1, wherein the switching converter is a power converter or switching regulator.

3. The active snubber of claim 1, further comprising a variable phase adjustment component and a variable amplitude adjustment component connected to the buffer and operating on the buffer drive signal.

4. The active snubber of claim 3, wherein a potential difference across the snubber is substantially null at f₂.

5. The active snubber of claim 1, further comprising a linear regulator following the switching converter and the active snubber, wherein the buffer input is connected to the linear regulator output.

6. The active snubber of claim 5, further comprising a variable phase adjustment component and a variable amplitude adjustment component connected to the buffer and operating on the buffer drive signal.
